(19) United States
(12) Patent Application Publication
(10) Pub. No.: US 2022/0019889 A1
(43) Pub. Date: Jan. 20, 2022

(54) EDGE ARTIFICIAL INTELLIGENCE DEVICE AND METHOD

(71) Applicant: SAMSUNG ELECTRO-MECHANICS CO., LTD., Suwon-si (KR)

(72) Inventor: Jae Goon AUM, Suwon-si (KR)

(73) Assignee: SAMSUNG ELECTRO-MECHANICS CO., LTD., Suwon-si (KR)

(21) Appl. No.: 17/067,062

(22) Filed: Oct. 9, 2020

(30) Foreign Application Priority Data
Jul. 20, 2020 (KR) 10-2020-0089662

(51) Int. Cl. G06N 3/08; G06N 3/04

(52) U.S. Cl. CPC G06N 3/08; G06N 3/0454

(57) ABSTRACT

An edge AI method and device are provided. The device includes one or more first neural network layers and one or more second neural network layers, each including plural second cells, where one first neural network layer, of the one or more first neural network layers, is connected to one second neural network layer of the one or more second neural network layers, and, for an operation of the one or more first neural network layers and the one or more second neural network layers, the device is configured to perform the operation according to first weight information, of the one or more first neural network layers, received from and trained outside of the device, and the device is configured to perform the operation according to second weight information, of the one or more second neural network layers, based on training of the second weight information by the device.

### CROSS-REFERENCE TO RELATED APPLICATION(S)

This application claims benefit of priority to Korean Patent Application No. 10-2020-0089662 filed on Jul. 20, 2020 in the Korean Intellectual Property Office, the disclosure of which is incorporated herein by reference in its entirety and for all purposes.

### BACKGROUND

### 1. Field

The present disclosure relates to an edge artificial intelligence device and method.

### 2. Description of Related Art

Many artificial intelligence services currently being developed perform learning and reasoning through an artificial intelligence cloud (AI Cloud), where a terminal (e.g., a mobile phone, or artificial intelligence speaker device) collects information through sensors and transmits that information to the AI Cloud, and then many processors or servers of the AI Cloud may perform the AI calculations for learning and for reasoning. For example, a method, in which a voice inquiry captured by an AI speaker is sent to a server of an AI Cloud, a processor or server of the AI Cloud determines an answer, and the answer is then sent back to the speaker. For training or learning, the artificial intelligence form, e.g., one or more neural networks, are trained at the AI Cloud level without the need of training any artificial intelligence form for use in the terminal. AI Cloud based reasoning, along with the AI Cloud training or learning, is often desirable because of the substantial processing capabilities of the underlying hardware, e.g., using connected and/or distributed server architectures, on the order of 1000 tops (tera operations per second), e.g., 1000 trillion operations (integer, floating, etc.,) each second.

However, with such an AI Cloud based reasoning approach there will always be a minimum amount of time necessary to encode and forward the collected information or captured inquiry to the AI Cloud, necessary time for the AI Cloud to determine a result based on training of the artificial intelligence service of the AI Cloud, and time necessary to receive and decode the result from the AI Cloud. In addition, there has also been a vulnerability to hacking because remote communications are required with this AI Cloud approach.

Accordingly, another approach is to implement all training and reasoning locally by the terminal through an edge intelligence (AI) chip of the terminal. As the performance of edge artificial intelligence (edge AI) chips improves, it is expected that an amount of data will increase and the edge AI chips will provide better services. However, compared to the current AI Cloud service calculation speeds, it is expected that an edge AI processing speed will be able to provide a very limited service due to the limitations of the terminal size and edge AI chip. For example, due to the limitations in the ability to process in typical edge AI computing, functions of the edge AI chip are very limitedly available with only 5-10 tops (tera operations per second). In this case, the functions that can be performed in one edge AI chip or IC are expected to be very limited, and to perform multiple functions it is expected that a device performing different respective functions would require numerous NPU ICs.

For example, an AI Engineer may develop a device through consideration of various input signals as inputs into a neural network and complex calculations can be performed by algorithms in each layer of the neural network to obtain a desired inference output. In this case, in order to analyze accurate information by increasing the accuracy of the calculation, various weights of the neural network may be iteratively assigned and trained for the desired inference objective. When weights are set for connections between each of many cells in various neural network layers, more interpretation can be performed. The greater the number of intermediate layers the greater potential for a better performance, but if too many layers are used too much training time is required for each appropriate layer through various trainings, e.g., through backpropagation of loss. As noted above, the AI Cloud approach has a speed that would enable the training of numerous layers and the use of those trained layers by the AI Cloud for input requests from a terminal. Rather, in an example of the edge AI in the terminal, training by the edge AI is typically impractical, especially as the numbers of layers and numbers of nodes/cells of each layer is increased.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a device includes one or more first neural network layers, each of the one or more first neural network layers including a plurality of first cells, and one or more second neural network layers, each of the one or more second neural network layers including a plurality of second cells, wherein one first neural network layer, of the one or more first neural network layers, is connected to one second neural network layer of the one or more second neural network layers, and for an operation of the one or more first neural network layers and the one or more second neural network layers, the device is configured to perform the operation according to first weight information, of the one or more first neural network layers, received from and trained outside of the device, and the device is configured to perform the operation according to second weight information, of the one or more second neural network layers, based on training of the second weight information by the device.

The device may be an electronic device, the operation may be an inference operation, and the first weight information may be received from another electronic device or a cloud system.

The first weight information may configure the one or more first neural network layers to perform feature extraction as a trained objective, and the second weight information may configure the one or more second neural network layers to determine an action or characteristic dependent on a result of the feature extraction.

The device may further include a communication module that periodically transmits variable parameter information to an external device or system, and receives updated trained first weight information from the outside of the other electronic device or the cloud system, where the first weight information may be replaced by the updated trained first weight information.

The transmission by the communication module, the receiving by the communication module, and replacements of weights of the one or more first neural network layers, based on the receiving by the communication module, may be performed multiple times before the device performs a training update of the second weight information.

The device may be an electronic device, the operation may be a training operation, and the first weight information may be received from another electronic device or a cloud system.

The first weight information may be received as variable parameter information of the electronic device is transmitted to the other electronic device or the cloud system.

The device may further include a memory storing variable parameter information, where the first weight information may be received as the variable parameter information is transmitted to the other electronic device or the cloud system.

The operation may be a training operation, and the device may be configured to perform a calculation process to update weights of the second weight information as the at least one first neural network layer is set to use the received first weight information.

The one or more first neural network layers may be configured to perform feature extraction, and the one or more second neural network layers may be configured for an action or characteristic determination dependent on a result of the feature extraction.

In one general aspect, an electronic device may include one or more inputs, and the above device as an edge artificial intelligence module of the electronic device, where the edge artificial intelligence module may be provided input information from at least one of the one or more inputs and may generate an inference output.

In one general aspect, a method of an electronic device may include setting one or more second neural network layers to use second weight information, obtaining variable parameter information, transmitting the variable parameter information to an external device or cloud system, receiving first weight information from outside of the electronic device as the variable parameter information is transmitted, and setting one or more first neural network layers to use the first weight information, wherein one of the one or more first neural network layers is connected to one of the one or more second neural network layers.

The one or more first neural network layers set to use the first weight information may represent the one or more first neural network layers being configured to perform a first trained objective with respect to the obtained variable parameter information, and the one or more second neural network layers set to use the second weight information may represent the one or more second neural network layers being configured to perform a second trained objective with respect to a result of an implementing of the one or more first neural network layers.

The first trained objective may be feature extraction, and the second trained objective may be an action or characteristic determination dependent on a result of the feature extraction.

The setting of the one or more first neural network layers to use the first weight information may include inputting input variable parameter information to a layer of the one or more first neural network layers, and performing training of the one or more second neural network layers based on a result of the one or more second neural network layers dependent on the input of the input variable parameter information.

The method may further include updating the second weight information after the electronic device sets the one or more first neural network layers to use the first weight information.

Each of the transmitting of the variable parameter information, the receiving of the first weight information, and the setting of the one or more first neural network layers to use the first weight information are repeatedly performed a greater number of times than the setting of the one or more second neural network layers to use the second weight information.

The second weight information may have a greater independence to the outside than the first weight information.

The outside may include the external electronic device or the cloud system.

### BRIEF DESCRIPTION OF DRAWINGS

The above and other aspects, features, and advantages of the present disclosure will be more clearly understood from the following detailed description taken in conjunction with the accompanying drawings, in which:

FIGS. 1A and 1B are views illustrating an edge artificial intelligence module according to one or more embodiments;

FIGS. 2A and 2B are views illustrating systems with an edge artificial intelligence module according to one or more embodiments;

FIGS. 3A and 3B are flowcharts illustrating a method of updating parameters of an edge artificial intelligence module according to one or more embodiments; and

FIG. 4 is a view illustrating parameters of an edge artificial intelligence module according to one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after gaining an understanding of the disclosure of this application. For example, the sequences of operations described herein are merely examples, and are not limited to those set forth herein, but may be changed as will be apparent after gaining an understanding of the disclosure of this application, with the exception of operations necessarily occurring in a certain order. Also, descriptions of features that are known in the art may be omitted for increased clarity and conciseness

The embodiments, however, may be embodied in various forms and should not be construed as limiting the scope of the present disclosure. Rather, the examples described herein have been provided merely to illustrate some of the many possible ways of implementing the methods, apparatuses, and/or systems described herein that will be apparent after an understanding of the disclosure of this application. Further, the embodiments are provided to fully describe the present disclosure to one of ordinary skill in the art. It should be understood that although various embodiments of the present invention are different from each other, they need not be mutually exclusive. For example, specific shapes, structures, or features described in the present specification may be modified for another embodiment without departing from the spirit and scope of the present invention.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof. The use of the term “may” herein with respect to an example or embodiment (for example, as to what an example or embodiment may include or implement) means that at least one example or embodiment exists where such a feature is included or implemented, while all examples are not limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly below,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as illustrated in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

Due to manufacturing techniques and/or tolerances, variations of the shapes illustrated in the drawings may occur. Thus, the examples described herein are not limited to the specific shapes illustrated in the drawings, but include changes in shape that occur during manufacturing

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

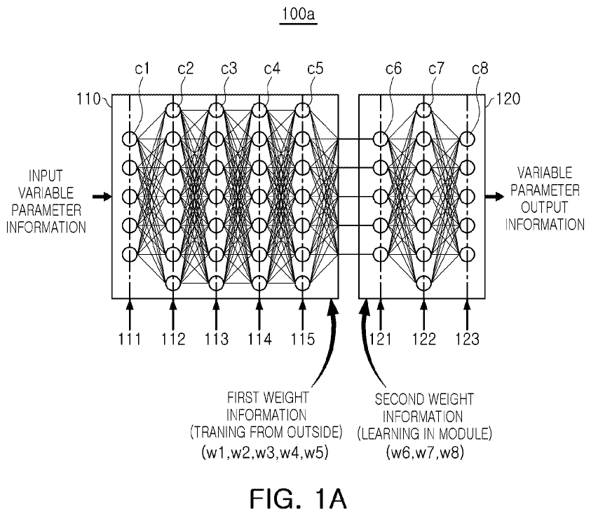

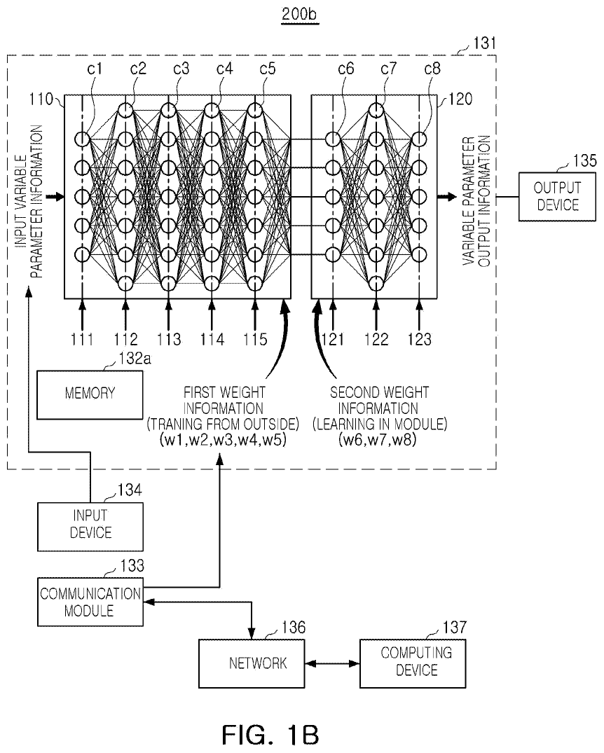

FIGS. 1A and 1B are views illustrating an edge artificial intelligence module according to one or more embodiments.

Herein, an edge artificial intelligence module is a hardware device, and referring to FIG. 1A, an edge artificial intelligence module according to one or more embodiments may include at least one first neural network layer 110 and at least one second neural network layer 120.

For example, at least one first neural network layer 110 and at least one second neural network layer 120 may be implemented as at least a portion of layers of a same neural processing unit (NPU) that may be included in the edge artificial intelligence module 100a. For example, in various embodiments the NPU may be implemented as an integrated circuit (IC), may be mounted on a substrate such as a PCB, and may be electrically connected to a wiring of the substrate, all of which are represented by the edge artificial intelligence module 100a of FIG. 1A, for example.

For example, at least one first neural network layer 110 may have a structure including plural first neural network layers in which a first neural network layer 111, including a plurality of first cells c1, a first neural network layer 112, including a plurality of first cells c2, a first neural network layer 113, including a plurality of first cells c3, a first neural network layer 114, including a plurality of first cells c4, and a first neural network layer 115, including a plurality of first cells c5, are sequentially connected to each other, as a non-limiting example.

For example, at least one second neural network layer 120 may have a structure including plural second neural network layers in which a second neural network layer 121, including a plurality of second cells c6, a second neural network layer 122, including a plurality of second cells c7, and a second neural network layer 123, including a plurality of second cells c8, are sequentially connected to each other, as a non-limiting example.

For example, at least one first neural network layer 110 and/or at least one second neural network layer 120 may be implemented as fully connected layer(s), a convolution network that can recognize image data, a recurrent neural network that can recognize data having continuous time characteristics such as a back propagation through time (BPTT) characteristic, may have a deep learning structure such as a long short-term memory (LSTM) method, and may be implemented with various types of layers such as an input layer or a hidden layer for one of the first neural network layers 110, and implemented with various layers such as a hidden layer and an output layer for one of the second neural network layers 120, in various example embodiments.

One first neural network layer 115 of the at least one first neural network layer 110 and one second neural network layer 121 of the at least one second neural network layer 120 may be connected to each other.

One first neural network layer 111 among at least one first neural network layer 110 may be provided input variable parameter information, and one second neural network layer 123 among at least one second neural network layer 120 may output variable parameter output information.

In an example, the edge artificial intelligence module 100a may calculate difference information between the variable parameter output information and the expected variable parameter output information, and update weight information of any of the neural network layers based on the difference information, e.g., iteratively update various weight information between any of the layers and the output through multiple passes and with respect to various input variable parameter information, and thus, may repeatedly calculate difference information between variable parameter output information and expected or labeled variable parameter output information after the weight information has been updated, for the updates of the weight information of the neural network layer based on the difference information. Accordingly, the difference between the variable parameter output information and the expected variable parameter output information can be gradually reduced, and the edge artificial intelligence module 100a can be trained.

These training processes can include many calculation processes, but if all training processes for all layer weight connections were performed many calculation processes could require great NPU performance and/or scale, which would require great total sizes and costs of an edge artificial intelligence module, as well as great size and unit cost of an electronic device in which such an edge artificial intelligence module is disposed.

In one or more embodiments, less than all layers of the edge artificial intelligence module 100a may be trained, or always trained, by the edge artificial intelligence module 100a. For example, the at least one first neural network layer 110 may include the plural first neural network layers and may be configured to receive first weight information (w1, w2, w3, w4, and w5) based on training from the outside of the edge artificial intelligence module 100a, while the at least one second neural network layer 120 may include the plural second neural network layers that are configured to have second weight information (w6, w7, and w8) that is more independent of the outside than the first weight information, e.g., with the second weight information being calculated by the edge artificial intelligence module 100a based on the aforementioned repetitive updating of weights based on the difference information.

For example, among a number of calculation processes included in the training process of the edge artificial intelligence module 100a, a calculation process corresponding to the first weight information may be performed outside of the edge artificial intelligence module 100a, so that a total amount of calculation in the training process of the edge artificial intelligence module 100a may be reduced compared to an example where the edge artificial intelligence module 100a always performed all calculations for training of all layers. Therefore, an overall size and a unit cost of the edge artificial intelligence module 100a according to one or more embodiments may be reduced compared to an edge artificial intelligence module that always performs all calculations for all training of all layers, and the size and unit cost of an electronic device in which the edge artificial intelligence module 100a is disposed may also be reduced compared to such an edge artificial intelligence module that always performs all calculations for all training of all layers.

For example, weights of at least one first neural network layer 110 may be obtained remotely, i.e., from the outside of the edge artificial intelligence module 100a, after having been trained outside of the edge artificial intelligence module 100a, while weights of at least one second neural network layer 120 may not be obtained remotely, but calculated by the edge artificial intelligence module 100a.

The obtained/received first weight information (w1, w2, w3, w4, and w5) may be applied to a plurality of first cells (c1, c2, c3, c4, and c5) of the first neural network layer (111, 112, 113, 114, and 115). For example, weights of the first neural network layer (111, 112, 113, 114, and 115) may be trained from an external neural network for a trained feature extraction objective. The second weight information (w6, w7, and w8) may be applied to a plurality of second cells (c6, c7, and c8) of the second neural network layers 121, 122, and 123. An order of applying the first weight information (w1, w2, w3, w4, and w5) and the second weight information (w6, w7, and w8) may vary depending on the performance of the NPU or the characteristics of the artificial intelligence function. When training of the second neural network layers 121, 122, and 123 is initially begun the second weight information (w6, w7, and w8) may be considered initial weights.

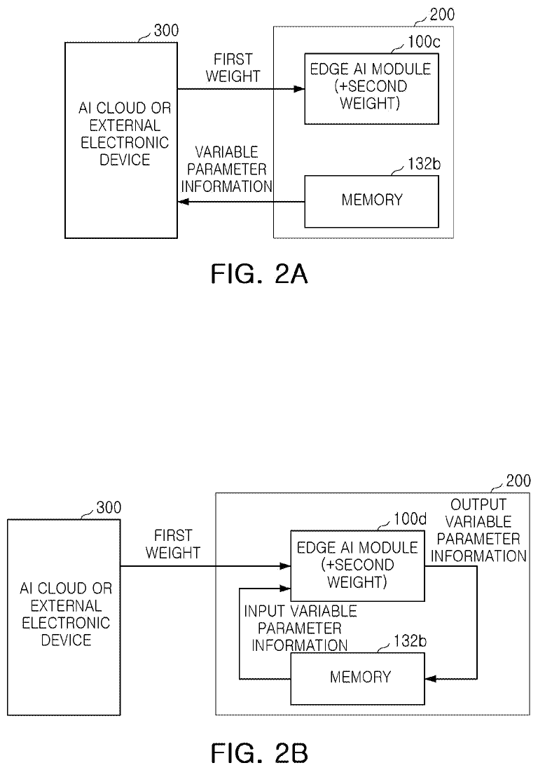

Referring to FIG. 1B, an electronic device 200b according to one or more embodiments may include an edge artificial intelligence module 131, a hardware communication module 133, an input device 134, and an output device 135, and may perform communications with a network 136 and computing device 137 through the communication module 133. The edge artificial intelligence module 131 may include a memory 132a. The electronic device 200b and the edge artificial intelligence module 131 may correspond to the electronic device and edge artificial intelligence modules discussed above with respect to FIG. 1A and below with respect to FIGS. 2A-4, as non-limiting examples.

For example, the electronic device 200b may be one of a smartphone, a personal digital assistant, a digital video camera, a digital still camera, a network system, a computer, a monitor, a tablet, a laptop, a netbook, a television, a video game, a smartwatch, and an automotive component, as non-limiting examples.

The memory 132a may store input variable parameter information. For example, the memory 132a may be a volatile memory (e.g., a RAM, etc.), a non-volatile memory (e.g., a ROM, a flash memory, etc.), or a combination thereof, and may be a storage such as magnetic storage or optical storage, and may store instructions corresponding to one or more or all methods described herein for updating a weight of the edge artificial intelligence module according to one or more embodiments, as well as corresponding inference operations.

The input device 134 may obtain an input signal corresponding to the input variable parameter information from an environment or vicinity of the electronic device 200b. For example, the input device 134 may be a keyboard, a mouse, a pen, a voice input device, a touch input device, a camera, a video input device, or the like.

For example, the electronic device 200b may store variable parameter information extracted by processing image information input from the input device 134, and transmit the variable parameter information to the outside of the electronic device 200b through the communication module 133.

The output device 135 may output an output signal corresponding to variable parameter output information. For example, the output device 135 may be a display, a speaker, a printer, or the like.

For example, depending on the trained objective of the second neural network layers 121, 122, and 123, the variable parameter output information may be data such as position determination of an object, distance time, and the like, and may be determination data for braking in a braking device or a control device, and data such as recognition and coordinates of an object or a person, distance recognition, and the like.

For example, the communication module 133 may be a modem, a network interface card (N IC), an integrated network interface, a radio frequency transmitter/receiver, an infrared port, a USB connection, or the like. The communication module 133 may transmit input variable parameter information to the outside of the electronic device 200b, and may receive first weight information from the outside of the electronic device 200b.

Here, the outside of the electronic device 200b may be a computing device 137. In an example, the computing device 137 may be one or more of an external electronic device same as the electronic device 200b and/or another one of the smartphone, personal digital assistant, digital video camera, digital still camera, network system, computer, monitor, tablet, laptop, netbook, television, video game, smartwatch, and automotive component. For example, computing device 137 may be a distributed computing environment including any of personal computer, a server computer, a handheld or a laptop device, a mobile device (a mobile phone, a PDA, a media player, etc.), a multiprocessor system, a consumer electronic device, a mini computer, a mainframe computer, and any combination of the aforementioned systems or devices, and may include a cloud system.

FIGS. 2A and 2B are views illustrating systems with an edge artificial intelligence module according to one or more embodiments.

Referring to FIG. 2A, an outside of an edge artificial intelligence module 100c according to one or more embodiments may be an electronic device 200 including the edge artificial intelligence module 100c, and/or may be an outside 300 of the electronic device 200. The outside 300 of the electronic device 200 may be a cloud or an external electronic device, as discussed above.

The edge artificial intelligence module 100c, e.g., at least one first neural network layer of the edge artificial intelligence module 100c, may be configured to receive first weight information from the outside 300 of the electronic device 200. For example, the edge artificial intelligence module 100c may periodically receive updates to the first weight information from the outside 300, the electronic device 200 or the edge artificial intelligence module 100c may periodically determine whether updates to the first weight information are remotely available and obtain such updates, or the electronic device 200 or the edge artificial intelligence module 100c may determine the availability of, and obtain, updates to the first weight information from the outside 300 based on a condition set in advance by a user of the electronic device 200 or user input information.

Accordingly, the edge artificial intelligence module 100c can more efficiently implement an artificial intelligence function that otherwise would have required a relatively large amount of calculations in the training process of the first weight information.

At least one first neural network layer of the edge artificial intelligence module 100c may be configured to receive first weight information as variable parameter information of the electronic device 200, in which the edge artificial intelligence module 100c is disposed, is transmitted to an external electronic device or a cloud.

Accordingly, the edge artificial intelligence module 100c can more efficiently improve the accuracy of the artificial intelligence function, which otherwise would have had a relatively large amount of calculations in the learning process of the first weight information.

At least one second neural network layer of the edge artificial intelligence module 100c may be configured to perform a calculation process for updating the weight of the second weight information as the at least one first neural network layer receives the first weight information.

Accordingly, the edge artificial intelligence module 100c may more efficiently learn the second weight information based on the learned/trained first weight information received from the outside 300.

Referring to FIG. 2B, an edge artificial intelligence module 100d according to one or more embodiments may receive input variable parameter information stored in a memory 132b. The input variable parameter information may be transmitted to the outside 300 of the electronic device 200. The memory 132b may be included in the electronic device 200 including the edge artificial intelligence module 100d, and/or may be included in the edge artificial intelligence module 100d.

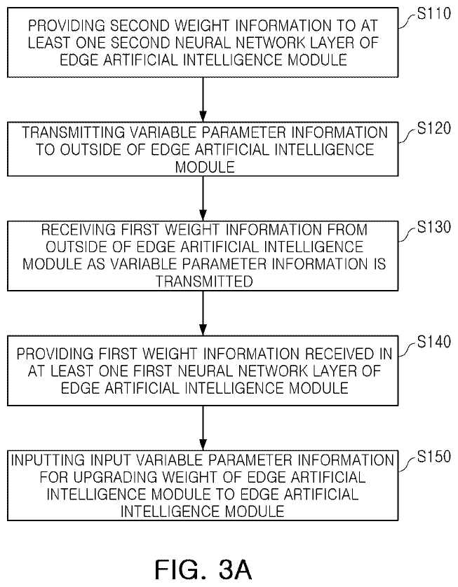

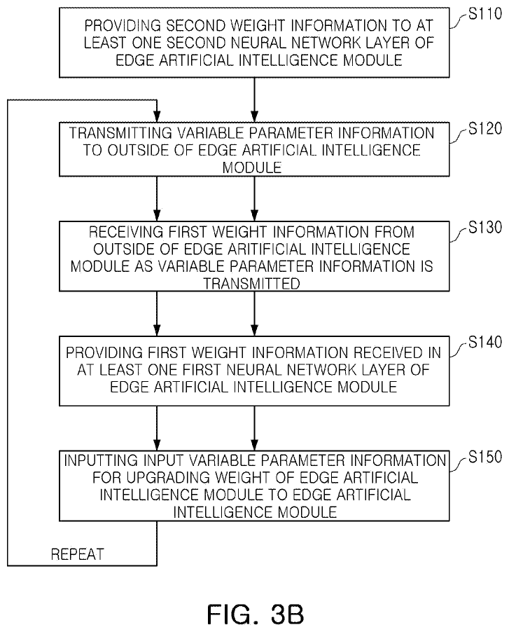

FIGS. 3A and 3B are flowcharts illustrating a method of updating parameters of an edge artificial intelligence module according to one or more embodiments.

Referring to FIG. 3A, according to the method of updating the weight of the edge artificial intelligence module, an electronic device may provide second weight information to at least one second neural network layer of the edge artificial intelligence module (S110), may transmit variable parameter information to an outside of the edge artificial intelligence module(S120), may receive first weight information from the outside of the edge artificial intelligence module as the variable parameter information is transmitted (S130), and may provide first weight information to at least one first neural network layer of the edge artificial intelligence module (S140).

Accordingly, among many calculation processes included in the learning process of the edge artificial intelligence module, a calculation process corresponding to the first weight information may be performed outside of the edge artificial intelligence module, so a total amount of calculations in the learning process of the edge artificial intelligence module may be reduced. Therefore, a total size and cost of the edge artificial intelligence module can be reduced, and a size and cost of an electronic device in which the edge artificial intelligence module is disposed can also be reduced.

According to the method for upgrading (updating) the weight of the edge artificial intelligence module according to one or more embodiments, the electronic device may input variable input information for upgrading (updating) the weight of the edge artificial intelligence module after providing the first weight information to the edge artificial intelligence module (S150).

Referring to FIG. 3B, each of the steps of transmitting variable parameter information (S120), receiving first weight information (S130), and providing first weight information (S140) may be repeatedly performed by a greater number of times than the operation of providing second weight information (S110).

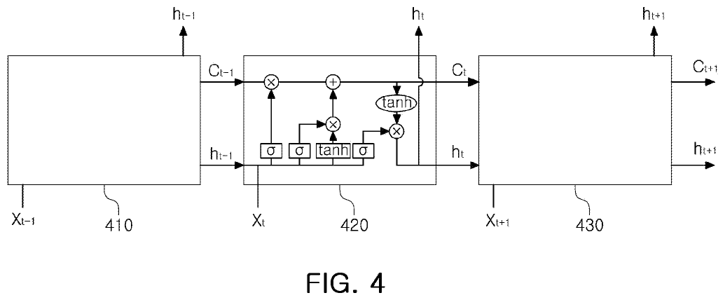

FIG. 4 is a view illustrating parameters of an edge artificial intelligence module according to one or more embodiments, and as a non-limiting example.

Referring to FIG. 4, a past neural network 410 may receive past input information xₜ₋₁ and output past output information hₜ₋₁ and past state information Cₜ₋₁.

A current neural network 420 may receive current input information xₜ, past output information hₜ₋₁, and past state information Cₜ₋₁, and may output current output information hₜ and current state information Cₜ.

A future neural network 430 may receive future input information xₜ₊₁, current output information hₜ, and current state information Cₜ, and may output future output information hₜ₊₁ and future state information Cₜ₊₁.

The neural network can generate a variable parameter using a sigmoid function (a) or a hyperbolic tangent function (tanh) on the current input information xₜ and the past output information hₜ₋₁, and may output the current output information hₜ through the variable parameter.

The sigmoid function (σ) and the hyperbolic tangent function (tanh) are functions that output an output value of 0 to 1 when an input value is one of 0 to infinity, and may give dynamic characteristics to an activation process of generating variable parameters of a neural network, by converting nonlinear input values into linear output values.

The neural network generated past output information hₜ₋₁ based on past input information xₜ₋₁, and may have past state information.

Thereafter, the neural network may select information to be discarded from the past state information Cₜ₋₁ using a function according to Equation 1 below.

fₜ=σ(Wₜ·[hₜ₋₁, xₜ]+b_{f}) Equation 1

In addition, the neural network can generate current state information Ct by generating information to be additionally stored from the past state information Cₜ₋₁ using functions according to Equations 2 to 4 below. Here, Wᵢ and W_{c} are first or second weight information, and b_{f} is a constant.

iₜ=σ(Wᵢ·[hₜ₋₁, xₜ]+bᵢ) Equation 2

\tilde{C}ₜ=tan h(W_{c}·[\tilde{h}ₜ₋₁, xₜ]+b_{c}) Equation 3

Cₜ=fₜ·Cₜ₋₁+iₜ·\tilde{C}ₜ Equation 4

In addition, the neural network may generate current output information hₜ using functions according to Equations 5 and 6 below.

Oₜ=σ(W₀·[hₜ₋₁, xₜ]+b₀) Equation 5

hₜ=Oₜ·tan h(Cₜ) Equation 6

Meanwhile, Wₜ, Wᵢ, and W_{c} are first or second weight information, and b_{f}, bᵢ, b_{c}, and bₒ are constants.

As set forth above, according to one or more embodiments, training of greater number of neural network layers of an edge artificial intelligence module may be available as training calculations of some of the neural network layers is performed remotely, and thus, the edge artificial intelligence module may provide a complex artificial intelligence function more quickly compared to a same performance/size edge artificial intelligence module that performs all calculations for training all neural network layers of the artificial intelligence modules.

The edge artificial intelligence modules, edge artificial intelligence module 100a, edge artificial intelligence module 200b, edge artificial intelligence module 100c, edge artificial intelligence module 100d, electronic devices, electronic devices 200 and 200b, input devices, input device 134, output devices, output device 135, communication modules, communication module 133, networks, network 136, computing device 137, memories, memory 132a, memory 132b, outside 300, AI cloud or external electronic devices, neural networks 410-430, other apparatuses, other modules, other devices, and other components described herein with reference to FIGS. 1A-4 are implemented by and representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers, which may also include in-memory processing. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that may be configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1A-4 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions used herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that may be configured to store the instructions or software and any associated data, data files, and data structures in a non-transitory manner and providing the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A device, the device comprising:
one or more first neural network layers, each of the one or more first neural network layers including a plurality of first cells; and
one or more second neural network layers, each of the one or more second neural network layers including a plurality of second cells,
wherein one first neural network layer, of the one or more first neural network layers, is connected to one second neural network layer of the one or more second neural network layers, and
for an operation of the one or more first neural network layers and the one or more second neural network layers,
the device is configured to perform the operation according to first weight information, of the one or more first neural network layers, received from and trained outside of the device, and
the device is configured to perform the operation according to second weight information, of the one or more second neural network layers, based on training of the second weight information by the device.

2. The device of claim 1, wherein device is an electronic device,
the operation is an inference operation, and
the first weight information is received from another electronic device or a cloud system.

3. The device of claim 2, wherein the first weight information configures the one or more first neural network layers to perform feature extraction as a trained objective, and the second weight information configures the one or more second neural network layers to determine an action or characteristic dependent on a result of the feature extraction.

4. The device of claim 2, further comprising a communication module that periodically transmits variable parameter information to an external device or system, and receives updated trained first weight information from the outside of the other electronic device or the cloud system,
wherein the first weight information are replaced by the updated trained first weight information.

5. The device of claim 4, wherein the transmission by the communication module, the receiving by the communication module, and replacements of weights of the one or more first neural network layers, based on the receiving by the communication module, are performed multiple times before the device performs a training update of the second weight information.

6. The device of claim 1, wherein the device is an electronic device,
the operation is a training operation, and
the first weight information is received from another electronic device or a cloud system.

7. The device of claim 6, wherein the first weight information is received as variable parameter information of the electronic device is transmitted to the other electronic device or the cloud system.

8. The device of claim 6, further comprising a memory storing variable parameter information,
wherein the first weight information is received as the variable parameter information is transmitted to the other electronic device or the cloud system.

9. The device of claim 1, wherein the operation is a training operation, and the device is configured to perform a calculation process to update weights of the second weight information as the at least one first neural network layer is set to use the received first weight information.

10. The device of claim 9, wherein the one or more first neural network layers are configured to perform feature extraction, and the one or more second neural network layers are configured for an action or characteristic determination dependent on a result of the feature extraction.

11. An electronic device, the electronic device comprising:
one or more inputs; and
the device of claim 1 as an edge artificial intelligence module of the electronic device,
wherein the edge artificial intelligence module is provided input information from at least one of the one or more inputs and generates an inference output.

12. A method of an electronic device, the method comprising:
setting one or more second neural network layers to use second weight information;
obtaining variable parameter information;
transmitting the variable parameter information to an external device or cloud system;
receiving first weight information from outside of the electronic device as the variable parameter information is transmitted; and
setting one or more first neural network layers to use the first weight information, wherein one of the one or more first neural network layers is connected to one of the one or more second neural network layers.

13. The method of claim 12,
wherein the one or more first neural network layers set to use the first weight information represents the one or more first neural network layers being configured to perform a first trained objective with respect to the obtained variable parameter information,
wherein the one or more second neural network layers set to use the second weight information represents the one or more second neural network layers being configured to perform a second trained objective with respect to a result of an implementing of the one or more first neural network layers.

14. The method of claim 13, wherein the first trained objective is feature extraction, and the second trained objective is an action or characteristic determination dependent on a result of the feature extraction.

15. The method of claim 12, wherein the setting of the one or more first neural network layers to use the first weight information includes inputting input variable parameter information to a layer of the one or more first neural network layers, and performing training of the one or more second neural network layers based on a result of the one or more second neural network layers dependent on the input of the input variable parameter information.

16. The method of claim 12, further comprising updating the second weight information after the electronic device sets the one or more first neural network layers to use the first weight information.

17. The method of claim 12, wherein each of the transmitting of the variable parameter information, the receiving of the first weight information, and the setting of the one or more first neural network layers to use the first weight information are repeatedly performed a greater number of times than the setting of the one or more second neural network layers to use the second weight information.

18. The method of claim 12, wherein the second weight information has a greater independence to the outside than the first weight information.

19. The method of claim 18, wherein the outside comprises the external electronic device or the cloud system.
